(19) United States
(12) Patent Application Publication
(10) Pub. No.: US 2013/0167947 A1
(43) Pub. Date: Jul. 4, 2013

(54) LIQUID SCATTERING PREVENTION CUP, SUBSTRATE PROCESSING APPARATUS PROVIDED WITH THE CUP, AND SUBSTRATE POLISHING APPARATUS

(71) Applicant: EBARA CORPORATION, Tokyo (JP)

(72) Inventors: Hisajiro NAKANO, Tokyo (JP); Koichi FUKAYA, Tokyo (JP)

(73) Assignee: EBARA CORPORATION, Tokyo (JP)

(21) Appl. No.: 13/727,726

(22) Filed: Dec. 27, 2012

(30) Foreign Application Priority Data
Dec. 28, 2011 (JP) 2011-287943

(51) Int. Cl. F16M 1/00

(52) U.S. Cl. CPC F16M 1/00
USPC 137/343

(57) ABSTRACT

There is provided a liquid scattering prevention cup which has a relatively simple construction and is easy to manufacture, has excellent durability, and can effectively prevent liquid droplets from bouncing off the inner peripheral surface of the cup. The liquid scattering prevention cup is disposed such that it surrounds a periphery of a substrate held and rotated by a substrate holding mechanism for preventing scattering of liquid droplets coming out of the rotating substrate. The liquid scattering prevention cup has a hydrophilic coating formed on at least part of the inner peripheral surface thereof and facing the substrate held and rotated by the substrate holding mechanism. The at least part of the inner peripheral surface has been subjected to surface roughening.

### CROSS REFERENCE TO RELATED APPLICATIONS

This document claims priority to Japanese Patent Application No. 2011-287943, filed on Dec. 28, 2011, the entire contents of which are hereby incorporated by reference.

### BACKGROUND OF THE INVENTION

1. Field of the Invention

The present invention relates to a liquid scattering prevention cup, disposed such that it surrounds a periphery of a substrate held by a substrate holding mechanism, for preventing scattering of a processing liquid coming out of the substrate. The liquid scattering prevention cup is provided in a substrate processing apparatus which includes the substrate holding mechanism for holding and rotating a substrate, such as a semiconductor wafer, a glass substrate or a liquid crystal panel, and which supplies a processing liquid to the substrate to process the substrate and, after the processing, rotates the substrate and causes the processing liquid to leave the substrate by centrifugal force. The present invention also relates to such a substrate processing apparatus provided with the liquid scattering prevention cup, and to a substrate polishing apparatus provided with the substrate processing apparatus.

2. Description of the Related Art

In a semiconductor device manufacturing process, for example, after carrying out copper plating or CMP (chemical mechanical polishing) processing of a surface of a substrate, such as a semiconductor wafer, cleaning of the surface of the substrate is commonly carried out to remove impurities or contaminants from the surface of the substrate.

A well-known substrate cleaning apparatus (substrate processing apparatus) for performing such cleaning of a substrate includes a substrate holding mechanism for holding and rotating a substrate in a horizontal position, and a processing liquid supply section (processing liquid supply nozzle) for supplying a processing liquid, such as a chemical solution or pure water, to front and back surfaces of the substrate held by the substrate holding mechanism. The apparatus performs cleaning of a substrate by supplying the processing liquid to the substrate while rotating the substrate, and subsequently supplying rinsing pure water to the substrate. After the cleaning of the substrate, it is common practice to spin-dry the substrate by rotating the substrate at a high speed so as to remove liquid droplets from the substrate by centrifugal force.

In the substrate cleaning apparatus, it is a conventional practice to use a liquid scattering prevention cup, disposed such that it surrounds a periphery of a substrate held by the substrate holding mechanism, in order to prevent liquid droplets, which leave the rotating substrate by centrifugal force during spin-drying, from scattering over a long distance. While such a conventional liquid scattering prevention cup can prevent long-distance scattering of liquid droplets from the substrate, it generally has been difficult to prevent liquid droplets, coming out of a substrate and colliding with the inner peripheral surface of the cup, from bouncing off and scattering from the inner peripheral surface. The liquid droplets, which have bounced off the inner peripheral surface of the liquid scattering prevention cup, can re-attach to the substrate, which may result in the formation of watermarks on the substrate surface.

Such watermarks formed on the substrate surface can cause a leak or poor adhesion in the watermark portion of the substrate, leading to lowering of the product yield. How to reduce the formation of watermarks is therefore an important issue to be solved.

A resin material having a relatively small contact angle with pure water or the like, such as PVC (polyvinyl chloride), is generally used for a liquid scattering prevention cup in order to prevent bouncing and scattering of liquid droplets from the inner peripheral surface of the liquid scattering prevention cup. However, the water contact angle of an unprocessed PVC surface is still as large as about 90 degrees; a liquid scattering prevention cup made of PVC cannot sufficiently prevent liquid droplets from bouncing off the inner peripheral surface of the cup.

Various proposals have been made to reduce the water contact angle, i.e., increase the hydrophilicity, of a liquid scattering prevention cup, e.g., made of PVC (see patent documents 1 to 4).

In particular, patent documents 1 to 4 have proposed the following surface treatment or processing of an inner peripheral surface of a liquid scattering prevention cup to increase the hydrophilicity of the surface: wet blasting with a slurry comprising a certain liquid and certain abrasive particles (patent document 1); physical processing, e.g., with a file, plasma processing, or the like (patent document 2); surface coating with a coating material containing glass fibers (film) or the formation of a titanium oxide film by plasma CVD (patent document 3); or the formation of a superhydrophilic layer, in particular a titanium oxide (TiO₂) photocatalytic film, followed by UV irradiation (patent document 4).

The applicant has proposed attachment of a hydrophilic member, such as a PVA sponge, to an inner peripheral surface of a liquid scattering prevention cup (see patent documents 5 and 6).

### PRIOR ART DOCUMENTS

Patent document 1: Japanese Patent Laid-Open Publication No. 2004-356299
Patent document 2: Japanese Patent Laid-Open Publication No. 2006-147672
Patent document 3: Japanese Patent Laid-Open Publication No. 2010-157528
Patent document 4: Japanese Patent Laid-Open Publication No. H10-258249
Patent document 5: Japanese Patent Laid-Open Publication No. 2010-149003
Patent document 6: Japanese Patent Laid-Open Publication No. 2009-117794

### SUMMARY OF THE INVENTION

When an inner peripheral surface of a liquid scattering prevention cup is made hydrophilic by forming a film of a hydrophilic material (titanium oxide photocatalytic film), followed by long-time UV irradiation, as described in patent document 3, for example, a long processing time is required in addition to the need for a UV irradiation apparatus. Further, the hydrophilic film is not considered to be sufficient in the durability (period during which the hydrophilicity can be maintained).

In the case of the conventional method for making an inner peripheral surface of a liquid scattering prevention cup hydrophilic by surface roughening, such as wet blasting, or by atmospheric-pressure plasma discharge, it is conceivable that the generation of impurities from the cup material cannot be avoided since the inner peripheral surface of the liquid scattering prevention cup is a plastic material, such as PVC, after processing. Further, the method using atmospheric-pressure plasma discharge necessitates an atmospheric-pressure plasma discharge apparatus.

The present invention has been made in view of the above situation. It is therefore an object of the present invention to provide a liquid scattering prevention cup which has a relatively simple construction and is easy to manufacture, has excellent durability, and can effectively prevent liquid droplets from bouncing off an inner peripheral surface thereof. It is also an object of the present invention to provide a substrate processing apparatus provided with the liquid scattering prevention cup, and a substrate polishing apparatus provided with the substrate processing apparatus.

In order to achieve the above object, the present invention provides a liquid scattering prevention cup, disposed such that it surrounds a periphery of a substrate held and rotated by a substrate holding mechanism, for preventing scattering of liquid droplets coming out of the rotating substrate. The liquid scattering prevention cup has a hydrophilic coating formed on at least part of an inner peripheral surface thereof and facing the substrate held and rotated by the substrate holding mechanism. The at least part of the inner peripheral surface has been subjected to surface roughening.

By thus subjecting at least part of the inner peripheral surface of the liquid scattering prevention cup to surface roughening and forming a hydrophilic coating on the roughened surface, it becomes possible to cover the base material of the cup with the hydrophilic coating with increased adhesion of the hydrophilic coating to the inner peripheral surface of the cup, and to hold liquid droplets, coming out of a substrate and colliding with the surface of the hydrophilic coating, on the surface of the hydrophilic coating while forming a liquid film on the hydrophilic coating and absorbing the liquid droplets into the liquid film, thereby preventing the liquid droplets from bouncing back onto the substrate.

The liquid scattering prevention cup is preferably made of a synthetic resin, such as PVC, having a relatively small contact angle with pure water or the like. Alternatively, the liquid scattering prevention cup may be made of a metal, such as aluminum.

Preferably, the at least part of the inner peripheral surface has been roughened by the surface roughening to a center line average roughness (Ra) of 0.5 to 5 μm. The surface roughening may preferably be performed by sand blasting using, e.g., fine SiC (silicon carbide) particles. The inner peripheral surface of the liquid scattering prevention cup can be roughened to a desired roughness by adjusting the blasting time and the particle size of the fine SiC particles.

The hydrophilic coating is preferably composed of SiO₂ or a semiconductor interlevel insulator material. SOG (spin-on glass) is an example of the semiconductor interlevel insulator material. The use of a semiconductor interlevel insulator material, which generally is of high purity and is resistant to chemicals, for the hydrophilic coating can prevent contamination of a substrate due to dissolution of the base material of the cup.

The hydrophilic coating preferably has a thickness of 0.5 to 2.0 μm. If the thickness exceeds 2.0 μm, there is a fear of the occurrence of cracking in the hydrophilic coating. If the thickness is less than 0.5 μm, there is a fear that the base material of the cup may be exposed.

The water contact angle of the hydrophilic coating is preferably not more than 60 degrees. This makes it possible to form the hydrophilic coating with good reproducibility.

The hydrophilic coating may be formed by, for example, spray coating. This makes it possible to form the hydrophilic coating easily and quickly.

The present invention also provides a substrate processing apparatus including the above-described liquid scattering prevention cup. The present invention also provides a substrate polishing apparatus including the substrate processing apparatus.

According to the present invention, at least part of the inner peripheral surface of the liquid scattering prevention cup is subjected to surface roughening, and a hydrophilic coating is formed on the roughened surface. This makes it possible to cover the base material of the cup with the hydrophilic coating with increased adhesion of the hydrophilic coating to the inner peripheral surface of the cup. This also makes it possible to hold liquid droplets, coming out of a substrate and colliding with the surface of the hydrophilic coating, on the surface of the hydrophilic coating while forming a liquid film on the hydrophilic coating and absorbing the liquid droplets into the liquid film, thereby preventing the liquid droplets from bouncing back onto the substrate. It therefore becomes possible to significantly reduce the formation of defects or watermarks on a surface of a substrate, caused by liquid droplets bouncing back onto the substrate.

### BRIEF DESCRIPTION OF THE DRAWINGS

FIG. 1 is a schematic cross-sectional view of a substrate processing apparatus (substrate cleaning apparatus) provided with a liquid scattering prevention cup according to an embodiment of the present invention;

FIG. 2 is an enlarged cross-sectional view of a main portion of the liquid scattering prevention cup shown in FIG. 1;

FIG. 3 is a diagram illustrating a hydrophilic coating as formed directly, without performing surface roughening, on an inner peripheral surface of a liquid scattering prevention cup;

FIG. 4 is a graph showing the water contact angles of hydrophilic coatings of samples 1 to 7 having the hydrophilic coatings with varying thicknesses, formed on the inner peripheral surfaces of the liquid scattering prevention cups, the surfaces having been subjected to surface roughening;

FIG. 5A is a diagram illustrating a hydrophilic coating formed on an inner peripheral surface of a liquid scattering prevention cup corresponding to samples 1 and 2, FIG. 5B is a diagram illustrating a hydrophilic coating formed on an inner peripheral surface of a liquid scattering prevention cup corresponding to samples 3 to 6, and FIG. 5C is a diagram illustrating a hydrophilic coating formed on an inner peripheral surface of a liquid scattering prevention cup corresponding to sample 7;

FIG. 6 is a schematic cross-sectional view of a substrate processing apparatus (substrate cleaning apparatus) provided with a liquid scattering prevention cup according to another embodiment of the present invention;

FIG. 7 is a graph showing the water contact angle of a surface of a PVC liquid scattering prevention cup (Comp. Example 1), the water contact angle of a surface of a PVC liquid scattering prevention cup, the surface having been subjected to roughening (Comp. Example 2), and the water contact angle of a hydrophilic coating formed on a surface of a PVC liquid scattering prevention cup, the surface having been subjected to roughening (Example 1);

FIG. 8 is a graph showing the number of defects in a substrate, as measured after cleaning the substrate using the liquid scattering prevention cup of Comp. Example 1, the number of defects in a substrate, as measured after cleaning the substrate using the liquid scattering prevention cup of Comp. Example 2, and the number of defects in a substrate, as measured after cleaning the substrate using the liquid scattering prevention cup of Example 1;

FIG. 9 is a graph showing a watermark formation frequency in a substrate, as measured after cleaning the substrate using the liquid scattering prevention cup of Comp. Example 2, and a watermark formation frequency in a substrate, as measured after cleaning the substrate using the liquid scattering prevention cup of Example 1;

FIG. 10 is a layout plan view of a substrate polishing apparatus provided with the substrate processing apparatus shown in FIG. 1 or 6; and

FIG. 11 is a schematic perspective view of the substrate polishing apparatus show in FIG. 10.

### DETAILED DESCRIPTION OF THE PREFERRED EMBODIMENTS

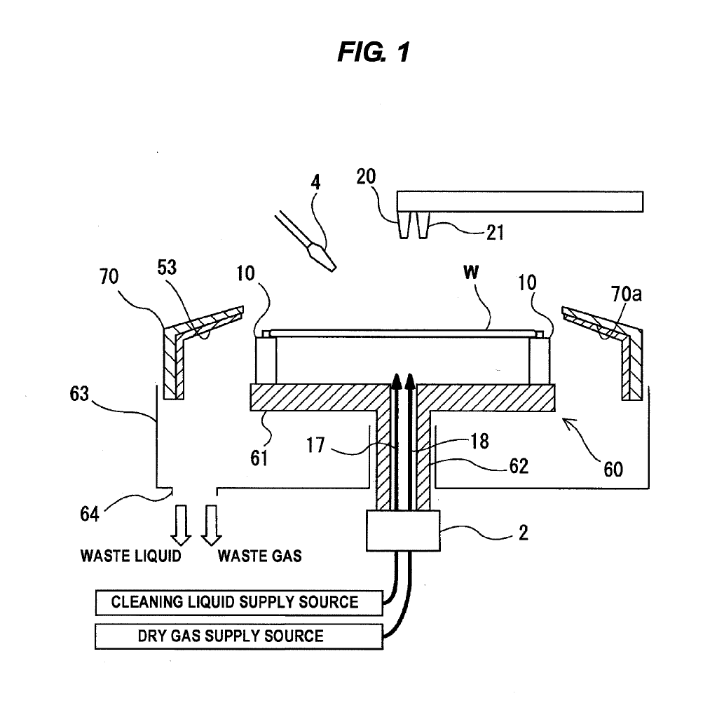

Preferred embodiments of the present invention will now be described in detail with reference to the drawings. FIG. 1 is a schematic cross-sectional view of a substrate processing apparatus (substrate cleaning apparatus) provided with a liquid scattering prevention cup according to an embodiment of the present invention.

As shown in FIG. 1, this substrate processing apparatus includes a substrate holding mechanism 60 for holding a substrate W in a horizontal position, a motor (rotating mechanism) 2 for rotating the substrate W on its axis held by the substrate holding mechanism 60, a liquid scattering prevention cup 70 according to an embodiment of the present invention, disposed around the periphery of the substrate W, and a front nozzle 4 for supplying pure water as a cleaning liquid to the surface (front surface) of the substrate W. The substrate holding mechanism 60 includes a stage 61, a hollow support shaft 62 supporting the stage 61, and a plurality of chucks 10 secured to an upper surface of the stage 61.

Within the support shaft 62 are disposed a back nozzle 17 connected to a cleaning liquid supply source, and a gas nozzle 18 connected to a dry gas supply source. Pure water as a cleaning liquid is stored in the cleaning liquid supply source, and is supplied through the back nozzle 17 to the back surface of the substrate W. N₂ gas or dry air, for example, is stored as a dry gas in the dry gas supply source, and is supplied through the gas nozzle 18 to the back surface of the substrate W.

The front nozzle 4 is directed toward the center of the substrate W. The front nozzle 4 is connected to a not-shown pure water supply source (cleaning liquid supply source), so that pure water is supplied through the front nozzle 4 to the center of the surface of the substrate W. Two parallel nozzles 20, 21 for performing Rotagoni drying are disposed above the substrate W. The nozzle 20 is to supply an IPA vapor (mixed gas of isopropyl alcohol and N₂ gas) to the surface of the substrate W, while the nozzle 21 is to supply pure water to the surface of the substrate W in order to prevent drying of the surface of the substrate W. The nozzles 20, 21 are configured to be movable in the radial direction of the substrate W.

The liquid scattering prevention cup 70 has an inner peripheral surface 70a whose upper portion is inclined radially inwardly. The top of the liquid scattering prevention cup 70 lies above the substrate W. A hydrophilic coating 53 is formed on an inner peripheral surface 70a of the liquid scattering prevention cup 70. The hydrophilic coating (liquid absorbent) 53 covers substantially the entire area of the inner peripheral surface 70a of the liquid scattering prevention cup 70.

A liquid receiver 63 for recovering a liquid (pure water as a cleaning liquid supplied from the front nozzle 4 and the back nozzle 17, and pure water supplied from the nozzle 21) is disposed under the stage 61 and the liquid scattering prevention cup 70. A discharge port 64 is provided in the bottom of the liquid receiver 63. The discharge port 64 is connected to a not-shown suction source so that the liquid recovered by the liquid receiver 63, together with ambient gas, is forcibly discharged through the discharge port 64.

The liquid scattering prevention cup 70 is generally cylindrical and has an inclined upper portion extending inwardly and upwardly. In this embodiment, PVC (polyvinyl chloride), which is a resin material having a relatively small contact angle with pure water or the like, is used as a base material for the liquid scattering prevention cup 70. Instead of PVC, it is possible to use other synthetic resins, such as PMMA (polymethyl methacrylate), PA (polyamide), PP (polypropylene), PE (polyethylene), etc. A metal such as aluminum may also be used.

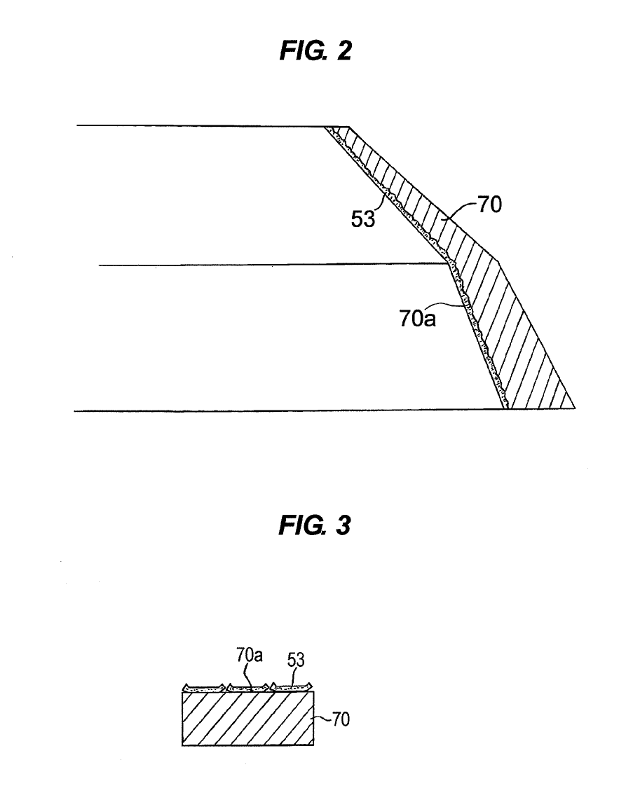

FIG. 2 is an enlarged cross-sectional view of a main portion of the liquid scattering prevention cup 70. As shown in FIG. 2, in this embodiment, substantially the entire area of the inner peripheral surface 70a of the liquid scattering prevention cup 70 is subjected to surface roughening. The surface roughening may be performed by sand blasting using, for example, fine SiC (silicon carbide) particles having a particle size of the order of #100. The inner peripheral surface (roughening surface) 70a of the liquid scattering prevention cup 70 is roughened to a center line average roughness (Ra) of, e.g., 0.5 to 5 μm. The inner peripheral surface (roughening surface) 70a of the liquid scattering prevention cup 70 can be roughened to a desired roughness by adjusting the blasting time.

The adhesion between the inner peripheral surface (roughening surface) 70a of the liquid scattering prevention cup 70 and the hydrophilic coating 53 formed thereon can be increased by thus roughening the inner peripheral surface (roughening surface) 70a of the liquid scattering prevention cup 70 to a center line average roughness (Ra) of, e.g., 0.5 to 5 μm. The surface roughening may be performed by sand blasting using, for example, fine SiC (silicon carbide) particles. The inner peripheral surface (roughening surface) 70a of the liquid scattering prevention cup 70 can be roughened to a desired roughness by adjusting the blasting time and the particle size of the fine SiC particles.

It is desirable that the inner peripheral surface (roughening surface) 70a of the liquid scattering prevention cup 70 after the surface roughening be cleaned by, for example, dry ice blasting so that the SiC particles used by sand blasting, etc. will not remain on the roughened surface.

The hydrophilic coating 53, e.g., having a thickness of 0.5 to 2.0 μm or having a water contact angle of not more than 60 degrees, is formed on the inner peripheral surface (roughening surface) 70a of the liquid scattering prevention cup 70 after the surface roughening. In this embodiment, the hydrophilic coating 53 is formed on the inner peripheral surface (roughening surface) 70a of the liquid scattering prevention cup 70 by spray coating with a coating material based on perhydropolysilazane (PHPS), followed by drying. NAX 120-20 (AZ Electronic Materials), for example, may preferably be used as the PHPS-based coating material.

A PHPS-based coating material is likely to convert to SiO₂ by reaction with moisture in the air. An inert gas, such as nitrogen gas, is therefore preferably used as a carrier gas. A too high concentration of the coating liquid may result in uneven coating. Therefore, the coating material (liquid), when used, is preferably diluted with an appropriate solvent (e.g., at a ratio of 1:1). The thickness of the hydrophilic coating 53 can be adjusted by adjusting the number of spray coating operations.

The hydrophilic coating 53 is composed of, for example, SiO₂ or a semiconductor interlevel insulator material. SOG (spin-on glass) is an example of the semiconductor interlevel insulator material. The use of a semiconductor interlevel insulator material, which generally is of high purity and is resistant to chemicals, for the hydrophilic coating 53 can prevent contamination of a substrate due to dissolution of the base material of the cup.

FIG. 3 illustrates a hydrophilic coating 53 as formed directly, without performing surface roughening, on the inner peripheral surface 70a of the liquid scattering prevention cup 70 made of PVC. The adhesion of the hydrophilic coating 53 to the inner peripheral surface 70a of the liquid scattering prevention cup 70 is thus significantly poorer when the hydrophilic coating 53 is formed directly on the inner peripheral surface 70a of the liquid scattering prevention cup 70.

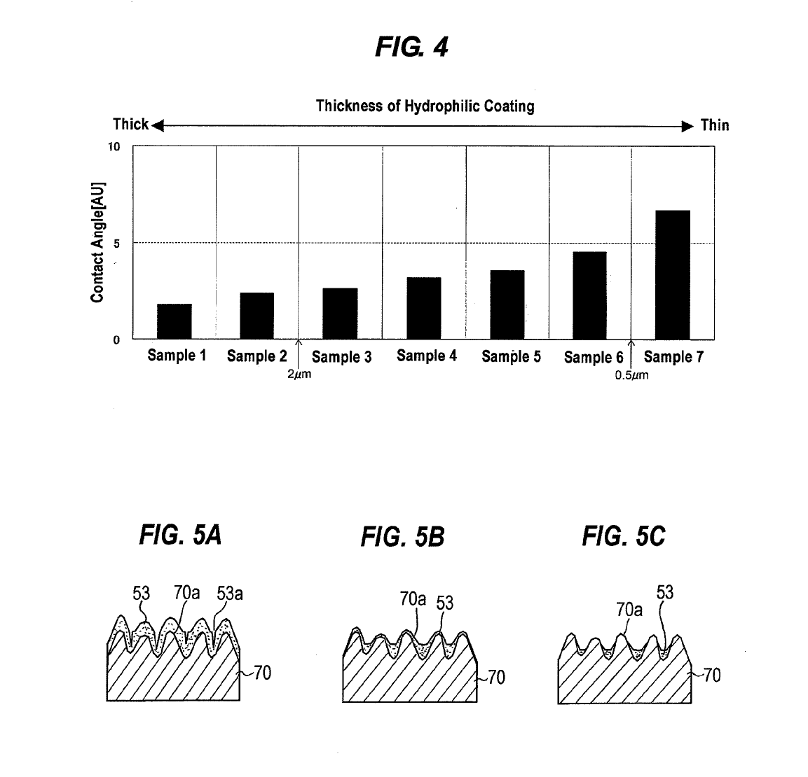

FIG. 4 shows the water contact angles of the hydrophilic coatings 53 of samples 1 to 7 having the hydrophilic coatings 53 with varying thicknesses, formed on the inner peripheral surfaces (roughening surfaces) 70a of the liquid scattering prevention cups 70, the surfaces having been subjected to surface roughening. FIG. 5A illustrates a hydrophilic coating 53 formed on an inner peripheral surface (roughening surface) 70a of a liquid scattering prevention cup 70 corresponding to samples 1 and 2, FIG. 5B illustrates a hydrophilic coating 53 formed on an inner peripheral surface (roughening surface) 70a of a liquid scattering prevention cup 70 corresponding to samples 3 to 6, and FIG. 5C illustrates a hydrophilic coating 53 formed on an inner peripheral surface (roughening surface) 70a of a liquid scattering prevention cup 70 corresponding to sample 7.

As can be seen in FIGS. 4 and 5A, cracks 53a are formed in the hydrophilic coating 53 when the thickness of the hydrophilic coating 53, formed on the inner peripheral surface (roughening surface) 70a of the liquid scattering prevention cup 70, exceeds 2 μm. As can be seen in FIGS. 4 and 5C, when the thickness of the hydrophilic coating 53, formed on the inner peripheral surface (roughening surface) 70a of the liquid scattering prevention cup 70, is less than 0.5 μm, the inner peripheral surface (roughening surface) 70a, especially the tops of raised portions, are exposed without being covered with the hydrophilic coating 53. In contrast, as can be seen in FIGS. 4 and 5B, the hydrophilic coating 53 is free of such drawbacks when the thickness is in the range of 0.5 to 2 μm.

Though in the above-described embodiment surface roughening and the subsequent formation of the hydrophilic coating 53 are performed in substantially the entire area of the inner peripheral surface 70a of the liquid scattering prevention cup 70, it is possible to perform surface roughening and the subsequent formation of the hydrophilic coating 53 in only part of the inner peripheral surface 70a of the liquid scattering prevention cup 70.

The operation of the substrate processing apparatus shown in FIG. 1 will now be described.

First, while rotating a substrate W by the motor 2, pure water is supplied from the front nozzle 4 and the back nozzle 17 to the front surface and the back surface of the substrate W, thereby rinsing the both surfaces of the substrate W with pure water. The pure water supplied to the substrate W is forced out of the rotating substrate W, captured by the liquid scattering prevention cup 70 and recovered by the liquid receiver 63. During the rinsing of the substrate W, the two nozzles 20, 21 are in a predetermined standby position at a distance from the substrate W.

Next, the supply of pure water is stopped. The front nozzle 4 is moved to a predetermined standby position at a distance from the substrate W, while the two nozzles 20, 21 are moved to a working position above the substrate W. While rotating the substrate W at a low speed of 150 to 300 min⁻¹, an IPA vapor and pure water are supplied from the nozzle 20 and the nozzle 21, respectively, to the front surface of the substrate W and, at the same time, pure water is supplied from the back nozzle 17 to the back surface of the substrate W. The two nozzles 20, 21 are moved simultaneously in the radial direction of the substrate W, whereby the front surface (upper surface) of the substrate W is dried.

Thereafter, the two nozzles 20, 21 are moved to the predetermined standby position, and the supply of pure water from the back nozzle 17 is stopped. The substrate W is then rotated at a high speed of 1000 to 1500 min⁻¹ so as to force pure water out of the back surface of the substrate W. During this operation, a dry gas is blown from the gas nozzle 18 onto the back surface of the substrate W in order to promote drying of the back surface of the substrate W.

During the above processing, the liquid (pure water), which has been forced out of the substrate W by centrifugal force, scatters outward in the form of liquid droplets and collides with the liquid scattering prevention cup 70. In this embodiment, the inner peripheral surface 70a of the liquid scattering prevention cup 70 has been subjected to surface roughening (blasting) and the subsequent formation of the hydrophilic film 53. Therefore, liquid droplets, colliding with the surface of the hydrophilic coating 53, are held on the surface of the hydrophilic coating 53 while a liquid film is formed on the hydrophilic coating 53 and the liquid droplets are absorbed into the liquid film. The liquid droplets can thus be prevented from bouncing back onto the substrate W.

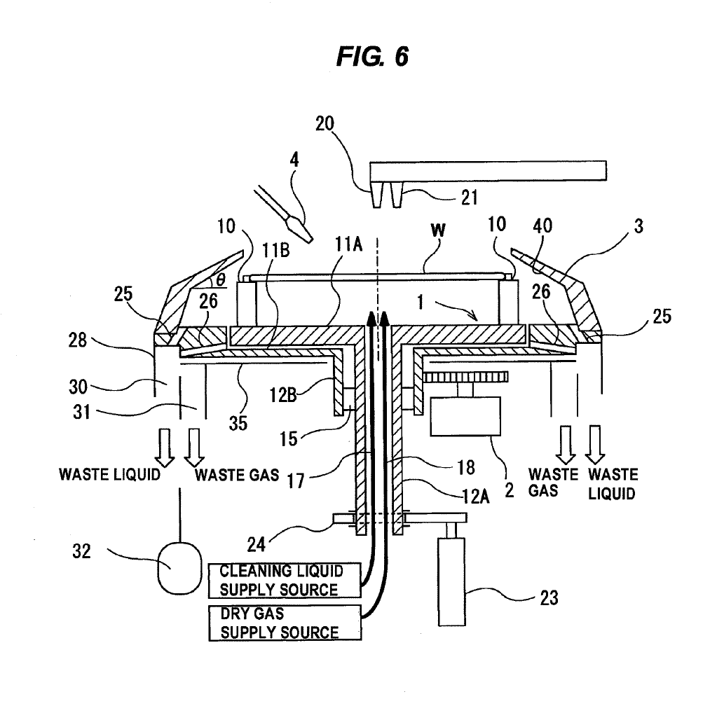

FIG. 6 is a schematic cross-sectional view of a substrate processing apparatus (substrate cleaning apparatus) provided with a liquid scattering prevention cup according to another embodiment of the present invention. As shown in FIG. 6, this substrate processing apparatus includes a substrate holding mechanism 1 for holding a substrate W in a horizontal position, a motor (rotating mechanism) 2 for rotating the substrate W on its axis held by the substrate holding mechanism 1, a liquid scattering prevention cup 3 according to another embodiment of the present invention, disposed around a periphery of the substrate W, and a front nozzle 4 for supplying pure water as a cleaning liquid to the surface (front surface) of the substrate W. Instead of pure water, it is possible to use a chemical solution as a cleaning liquid.

The substrate holding mechanism 1 includes a plurality of chucks 10 for gripping the periphery of the substrate W, a first circular stage 11A to which the chucks 10 are secured, a hollow first support shaft 12A supporting the first stage 11A, a second circular stage 11B having a recess in which the first stage 11A is housed, and a hollow second support shaft 12B supporting the second stage 11B. The first support shaft 12A extends through the second support shaft 12B. Thus, the first stage 11A, the second sage 11B, the first support shaft 12A and the second support shaft 12B are arranged coaxially. The liquid scattering prevention cup 3 is secured at the peripheral end of the second stage 11B and is disposed coaxially with the second stage 11B. The substrate W held by the chucks 10 lies coaxially with the liquid scattering prevention cup 3.

The first support shaft 12A and the second support shaft 12B are connected by a linear motion guide mechanism 15. The linear motion guide mechanism 15 enables torque transmission between the first support shaft 12A and the second support shaft 12B while permitting relative movement between the first support shaft 12A and the second support shaft 12B in the longitudinal direction (axial direction). A ball spline bearing, for example, may be used as the linear motion guide mechanism 15.

The motor 2 is coupled to the peripheral surface of the second support shaft 12B. The torque of the motor 2 is transmitted to the first support shaft 12A via the linear motion guide mechanism 15, so that the substrate W held by the chucks 10 is rotated. The first stage 11A and the second sage 11B rotate in synchronization via the linear motion guide mechanism 15. Thus, the substrate W and the liquid scattering prevention cup 3 rotate in synchronization at a relative speed of 0. There may be a small difference in the rotational speed between the substrate W and the liquid scattering prevention cup 3. In that case, separate rotating mechanisms can be used to rotate the substrate W and the liquid scattering prevention cup 3, respectively. The substrate W and the liquid scattering prevention cup 3 may thus be rotated at approximately the same speed. The expression “the same speed” herein refers to the same angular speed (velocity) in the same direction.

An actuator 23 as a vertical movement mechanism is coupled via a coupling mechanism 24 to the first support shaft 12A. The coupling mechanism 24 transmits the driving force of the actuator 23 in the axial direction to the first support shaft 12A while permitting rotation of the first support shaft 12A. The actuator 23 vertically moves the first stage 11A, the first support shaft 12A and the chucks 10 (and thus the substrate W) via the coupling mechanism 24. Thus, the actuator 23 functions as a relative movement mechanism for moving the substrate W in the axial direction (direction of the axis of rotation) relative to the liquid scattering prevention cup 3.

Within the first support shaft 12A are disposed a back nozzle 17 connected to a cleaning liquid supply source, and a gas nozzle 18 connected to a dry gas supply source. Pure water as a cleaning liquid is stored in the cleaning liquid supply source, and is supplied through the back nozzle 17 to the back surface of the substrate W. N₂ gas or dry air, for example, is stored as a dry gas in the dry gas supply source, and is supplied through the gas nozzle 18 to the back surface of the substrate W.

The front nozzle 4 is directed toward the center of the substrate W. The front nozzle 4 is connected to a not-shown pure water supply source (cleaning liquid supply source), so that pure water is supplied through the front nozzle 4 to the center of the surface of the substrate W. Two parallel nozzles 20, 21 for performing Rotagoni drying are disposed above the substrate W. The nozzle 20 supplies an IPA vapor (mixed gas of isopropyl alcohol and N₂ gas) to the surface of the substrate W, while the nozzle 21 supplies pure water to the surface of the substrate W in order to prevent drying of the surface of the substrate W. The nozzles 20, 21 are configured to be movable in the radial direction of the substrate W.

The second stage 11B has a plurality of discharge holes 25. Each discharge hole 25 has an upper opening lying at the lower end of the liquid scattering prevention cup 3, and a lower opening lying in the lower surface of the second stage 11B. Each discharge hole 25 is a long hole extending in the circumferential direction of the liquid scattering prevention cup 3, and inclines radially outward and downward from the upper opening to the lower opening. The cleaning liquid (pure water) supplied from the front nozzle 4 and the back nozzle 17, and pure water supplied from the nozzle 21, together with the gas from the gas nozzle 18 and the ambient atmosphere (usually air), are discharged through the discharge holes 25.

The second stage 11B also has a plurality of auxiliary discharge holes 26 for discharging a liquid (cleaning liquid, pure water) that has entered the space between the first stage 11A and the second stage 11B. Each auxiliary discharge hole 26 has an upper opening lying in the space between the first stage 11A and the second stage 11B, and a lower opening lying in the lower surface of the second stage 11B. As with the above-described discharge holes 25, the auxiliary discharge holes 26 each inclines radially outward and downward from the upper opening to the lower opening.

An annular liquid discharge passage 30 and an annular gas discharge passage 31 are provided below the lower openings of the discharge holes 25 and the lower openings of the auxiliary discharge holes 26. The liquid discharge passage 30 is disposed radially outside the gas discharge passage 31. With this structure, a gas/liquid mixture, discharged from the discharge holes 25 and the auxiliary discharge holes 26, is separated into a gas and a liquid by centrifugal force; the liquid flows into the liquid discharge passage 30, and the gas flows into the gas discharge passage 31.

The gas discharge passage 31 is connected to a vacuum source (e.g., vacuum pump) 32, so that a downward flow from the surface of the substrate W, passing through the discharge holes 25 and the gas discharge passage 31, is created.

A disk-shaped fixed plate 35 is disposed below the second stage 11B, with a small gap being formed between the fixed plate 35 and the lower surface of the second stage 11B. The fixed plate 35 prevents turbulence of ambient gas due to the rotation of the second stage 11B. A downwardly-extending cylindrical skirt 28 is secured to the peripheral edge of the second stage 11B. The skirt 28 is provided to prevent scattering of the liquid discharged from the discharge holes 25 and the auxiliary discharge holes 26 and to distance the liquid release position from the substrate W.

The liquid scattering prevention cup 3 has an inner peripheral surface (see FIG. 2) that surrounds the periphery of the substrate W held by the substrate holding mechanism 1. The upper end of the inner peripheral surface of the liquid scattering prevention cup 3 lies above the substrate W. The diameter of the inner peripheral surface (the inner diameter of the liquid scattering prevention cup 3) gradually decreases with height. Thus, the inner peripheral surface of the liquid scattering prevention cup 3 is inclined radially inward as a whole and makes an angle θ of less than 90 degrees with a horizontal plane.

Though the cross-sectional shape of the inner peripheral surface of the liquid scattering prevention cup 3 is composed of two inclined lines, this is not limitative of the present invention.

The diameter of the liquid scattering prevention cup 3 at the top is slightly larger than the diameter of the substrate W. The bottom of the liquid scattering prevention cup 3 partly overlaps the upper openings of the discharge holes 25 so as to introduce a liquid, flowing down along the inner peripheral surface of the liquid scattering prevention cup 3, smoothly into the discharge holes 25. If the upper openings of the discharge holes 25 are located at a distance from the bottom of the liquid scattering prevention cup 3, a liquid, flowing down along the inner peripheral surface of the liquid scattering prevention cup 3, will collide with the upper surface of the second stage 11B and will not flow smoothly into the discharge holes 25. According to the arrangement of the discharge holes 25 of this embodiment, the downward-flowing liquid does not collide with the upper surface of the second stage 11B and flows smoothly into the discharge holes 25.

As in the preceding embodiment, PVC (polyvinyl chloride), which is a resin material having a relatively small contact angle with pure water or the like, is used as a base material for the liquid scattering prevention cup 3. As described above, instead of PVC, it is possible to use other synthetic resins, such as PMMA (polymethyl methacrylate), PA (polyamide), PP (polypropylene), PE (polyethylene), etc. A metal such as aluminum may also be used.

As in the preceding embodiment, substantially the entire area of the inner peripheral surface of the liquid scattering prevention cup 3 is subjected to sand blasting. A hydrophilic coating 40, e.g., having a thickness of 0.5 to 2.0 μm or having a water contact angle of not more than 60 degrees, is formed on the inner peripheral surface (roughening surface) of the liquid scattering prevention cup 3 after the surface roughening. The hydrophilic coating 40 is formed, for example, by spray coating with a coating material based on perhydropolysilazane (PHPS), followed by drying.

The operation of the substrate processing apparatus shown in FIG. 6 will now be described.

First, while rotating a substrate W and the liquid scattering prevention cup 3 by the motor 2, pure water is supplied from the front nozzle 4 and the back nozzle 17 to the front surface (upper surface) and the back surface (lower surface) of the substrate W, thereby rinsing the both surfaces of the substrate W with pure water. Pure water supplied to the substrate W spreads over the front and back surfaces by centrifugal force, whereby the entire surface the substrate W is rinsed with pure water. Pure water that has been forced out of the rotating substrate W is captured by the liquid scattering prevention cup 3, and then flows into the discharge holes 25. During the rinsing of the substrate W, the two nozzles 20, 21 are in a predetermined standby position at a distance from the substrate W.

Next, the supply of pure water from the front nozzle 4 is stopped. The front nozzle 4 is moved to a predetermined standby position at a distance from the substrate W, while the two nozzles 20, 21 are moved to a working position above the substrate W.

While rotating the substrate W at a low speed of 150 to 300 min⁻¹, an IPA vapor and pure water are supplied from the nozzle 20 and the nozzle 21, respectively, to the front surface of the substrate W and, at the same time, pure water is supplied from the back nozzle 17 to the back surface of the substrate W. The two nozzles 20, 21 are moved simultaneously in the radial direction of the substrate W, whereby the front surface (upper surface) of the substrate W is dried.

Thereafter, the two nozzles 20, 21 are moved to the predetermined standby position, and the supply of pure water from the back nozzle 17 is stopped. The substrate W is then rotated at a high speed of 1000 to 1500 min⁻¹ so as to force pure water out of the back surface of the substrate W. During this operation, a dry gas is blown from the gas nozzle 18 onto the back surface of the substrate W in order to promote drying of the back surface.

As described above, pure water is supplied to the front and back surfaces of the substrate W during the cleaning/drying process for the substrate W. The pure water supplied to the substrate W is forced out of the substrate W by centrifugal force and scatters outward in the form of droplets, and collides with the liquid scattering prevention cup 3. In this embodiment, the inner peripheral surface of the liquid scattering prevention cup 3 has been subjected to surface roughening (blasting) and the subsequent formation of the hydrophilic film 40. Therefore, liquid droplets, colliding with the surface of the hydrophilic coating 40, are held on the surface of the hydrophilic coating 40 while a liquid film, into which the liquid droplets are absorbed, is formed on the hydrophilic coating 40. The liquid droplets can thus be prevented from bouncing back onto the substrate W.

Upon the completion of drying of the substrate W, the supply of the dry gas from the gas nozzle 18 is stopped. The substrate W is then raised by the actuator 23 to a position above the liquid scattering prevention cup 3. The dried substrate W is then taken out of the substrate holding mechanism 1 by hands of a not-shown transfer robot.

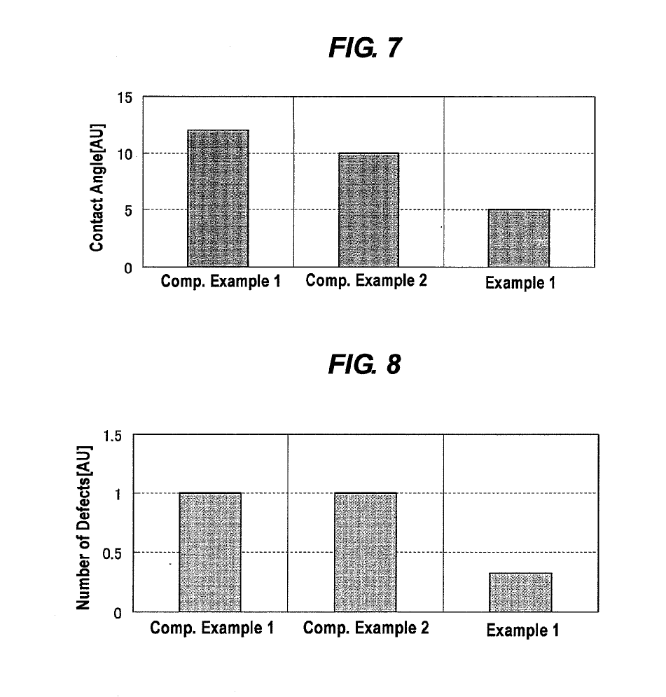

FIG. 7 is a graph showing the water contact angle of a surface (inner peripheral surface) of a PVC liquid scattering prevention cup (Comp. Example 1), the water contact angle of a surface (inner peripheral surface) of a PVC liquid scattering prevention cup, the surface having been subjected to roughening (blasting) (Comp. Example 2), and the water contact angle of a hydrophilic coating formed on a surface (inner peripheral surface) of a PVC liquid scattering prevention cup, the surface having been subjected to roughening (blasting) (Example 1).

FIG. 8 is a graph showing the number of defects in a substrate, as measured after cleaning the substrate using the liquid scattering prevention cup of Comp. Example 1, the number of defects in a substrate, as measured after cleaning the substrate using the liquid scattering prevention cup of Comp. Example 2, and the number of defects in a substrate, as measured after cleaning the substrate using the liquid scattering prevention cup of Example 1.

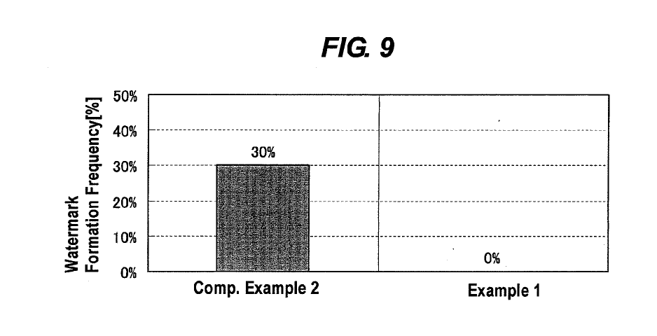

FIG. 9 is a graph showing a watermark formation frequency in a substrate, as measured after cleaning the substrate using the liquid scattering prevention cup of Comp. Example 2, and a watermark formation frequency in a substrate, as measured after cleaning the substrate using the liquid scattering prevention cup of Example 1.

As can be seen in FIGS. 7 and 8, the water contact angle of the surface (inner peripheral surface) of the liquid scattering prevention cup can be reduced by performing surface roughening (blasting). However, the surface roughening cannot effectively reduce the number of defects observed in a substrate after cleaning. In contrast, both the water contact angle of the liquid scattering prevention cup and the number of defects in a substrate after cleaning can be significantly reduced by subjecting the surface (inner peripheral surface) of the liquid scattering prevention cup to the surface roughening (blasting) and the subsequent formation of the hydrophilic coating.

As can be seen in FIG. 9, compared to the case of merely subjecting the surface (inner peripheral surface) of the liquid scattering prevention cup to the surface roughening (blasting), the watermark formation frequency in a substrate after cleaning can be significantly reduced by subjecting the surface (inner peripheral surface) of the liquid scattering prevention cup to the surface roughening (blasting) and the subsequent formation of the hydrophilic coating.

The following may be considered in this regard: Liquid droplets, coming from a substrate and colliding with the surface of the hydrophilic coating, are held on the surface of the hydrophilic coating to form a liquid film on the hydrophilic coating. The liquid film absorbs liquid droplets, thereby preventing the liquid droplets from bouncing back onto the substrate. Furthermore, the generation of impurities from the base material of the liquid scattering prevention cup can be prevented by covering the base material with the hydrophilic coating such that the base material does not expose outside. The formation of defects and watermarks in the substrate, caused by liquid droplets bouncing back onto the substrate, can therefore be significantly reduced.

Further, the hydrophilic coating can prevent contamination of the substrate due to dissolution of the base material of the liquid scattering prevention cup. Furthermore, by forming the hydrophilic coating after subjecting the surface (inner peripheral surface) of the liquid scattering prevention cup to the surface roughening, the contact area between the hydrophilic coating and the inner peripheral surface of the cup increases, and therefore the adhesion between them increases. The hydrophilic coating is therefore less likely to separate from the surface (inner peripheral surface) of the liquid scattering prevention cup. In addition, the hydrophilic film is free of maintenance and can be formed relatively easily by spray coating, without using a costly method, such as plasma CVD, or a method which requires a post-treatment or maintenance operation such as re-irradiation with UV light.

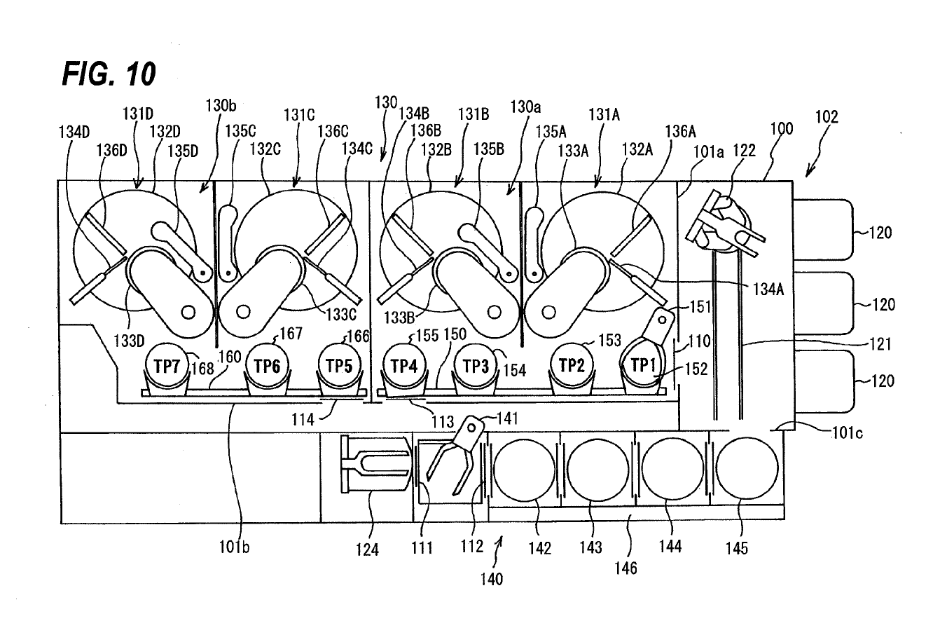

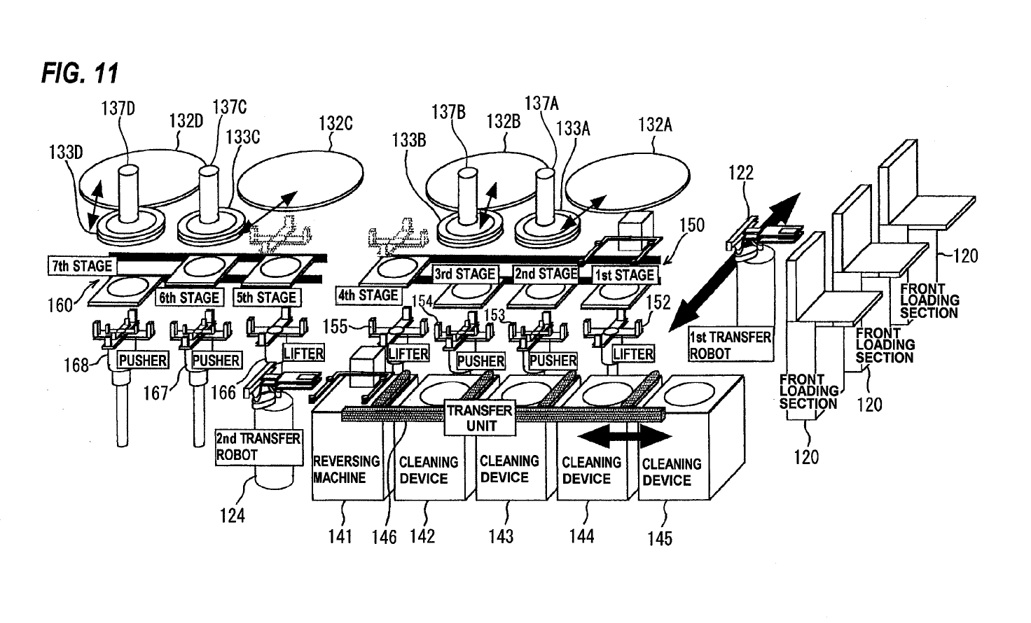

Next, a substrate polishing apparatus provided with the substrate processing apparatus shown in FIG. 1 or 6 will be described. FIG. 10 is a layout plan view of the substrate polishing apparatus provided with the substrate processing apparatus shown in FIG. 1 or 6, and FIG. 11 is a schematic perspective view of the substrate polishing apparatus show in FIG. 10. As shown in FIG. 10, the substrate polishing apparatus has a housing 100 in a substantially rectangular form. An interior space of the housing 100 is divided into a loading/unloading section 120, a polishing section 130 (130a, 130b), and a cleaning/drying section 140 by partition walls 101a, 101b, 101c.

The loading/unloading section 102 has two or more front loading sections (e.g., three front loading sections in FIG. 10), on which substrate cassettes, each storing a number of substrates, are placed. The front loading sections 120 are arranged adjacent to each other along a width direction (a direction perpendicular to a longitudinal direction) of the polishing apparatus. Each of the front loading sections 120 can receive thereon an open cassette, an SMIF (Standard Manufacturing Interface) pod, or a FOUP (Front Opening Unified Pod). The SMIF and FOUP are a hermetically sealed container which houses a substrate cassette therein and is covered with a partition wall to provide an interior environment isolated from an external space.

A moving mechanism 121, extending along the line of the front loading sections 120, is provided in the loading/unloading section 102. On the moving mechanism 121 is provided a first transfer robot 122 which is movable along the direction in which the front loading sections 120 are arranged. The first transfer robot 122 can reach the substrate cassettes placed in the front loading sections 120 by moving on the moving mechanism 121. The first transfer robot 122 has two hands, an upper hand and a lower hand, and can use the two hands differently, for example, by using the upper hand when returning a polished substrate to a substrate cassette and using the lower hand when transferring an unpolished substrate.

The loading/unloading section 102 is required to be a cleanest area. Therefore, pressure in the interior of the loading/unloading section 102 is kept higher at all times than pressures in the exterior space of the apparatus, the polishing section 130 and the cleaning section 140. Further, a filter fan unit (not shown in the drawings) having a clean air filter, such as HEPA filter or ULPA filter, is provided above the moving mechanism 121 of the first transfer robot 122. This filter fan unit removes particles, toxic vapor, and toxic gas from air to produce clean air, and forms a downward flow of the clean.

The polishing section 130 is an area where a substrate is polished. The polishing section 130 includes a first polishing section 130a having a first polishing unit 131A and a second polishing unit 131B therein, and a second polishing section 130b having a third polishing unit 131C and a fourth polishing unit 131D therein. The first polishing unit 131A, the second polishing unit 131B, the third polishing unit 131C, and the fourth polishing unit 131D are arranged along the longitudinal direction of the polishing apparatus, as shown in FIG. 10.

The first polishing unit 131A includes a polishing table 132A holding a polishing pad, a top ring 133A for holding a substrate and pressing the substrate against the polishing surface of the polishing pad on the polishing table 132A, a polishing liquid supply nozzle 134A for supplying a polishing liquid (e.g., a slurry) or a dressing liquid (e.g., pure water) onto the polishing surface of the polishing pad, a dresser 135A for dressing the polishing pad, and an atomizer 136A having nozzles for ejecting a mixture of a liquid (e.g., pure water) and a gas (e.g., nitrogen) in an atomized state to the polishing surface.

Similarly, the second polishing unit 131B includes a polishing table 132B, a top ring 133B, a polishing liquid supply nozzle 134B, a dresser 135B, and an atomizer 136B. The third polishing unit 131C includes a polishing table 132C, a top ring 133C, a polishing liquid supply nozzle 134C, a dresser 135C, and an atomizer 136C. The fourth polishing unit 131D includes a polishing table 132D, a top ring 133D, a polishing liquid supply nozzle 134D, a dresser 135D, and an atomizer 136D.

A first linear transporter 150 is provided in the first polishing section 130a. This first linear transporter 150 is configured to transfer a substrate between four transferring positions located along the longitudinal direction of the polishing apparatus (hereinafter, these four transferring positions will be referred to as a first transferring position TP1, a second transferring position TP2, a third transferring position TP3, and a fourth transferring position TP4 in the order from the loading/unloading section). A reversing machine 151 for reversing a substrate transferred from the first transfer robot 122 is disposed above the first transferring position TP1 of the first linear transporter 150. A vertically movable lifter 152 is disposed below the first transferring position TP1. A vertically movable pusher 153 is disposed below the second transferring position TP2, a vertically movable pusher 154 is disposed below the third transferring position TP3, and a vertically movable lifter 155 is disposed below the fourth transferring position TP4, respectively.

In the second polishing section 130b, a second linear transporter 160 is provided next to the first linear transporter 150. This second linear transporter 160 is configured to transfer a substrate between three transferring positions located along the longitudinal direction of the polishing apparatus (hereinafter, these three transferring positions will be referred to as a fifth transferring position TP5, a sixth transferring position TP6, and a seventh transferring position TP7 in the order from the loading/unloading section). A vertically movable lifter 166 is disposed below the fifth transferring position TP5 of the second linear transporter 160, a pusher 167 is disposed below the sixth transferring position TP6, and a pusher 168 is disposed below the seventh transferring position TP7, respectively.

As shown in FIG. 11, the first linear transporter 150 has four transfer stages: a first stage, a second stage, a third stage, and a fourth stage, which are linearly movable in a reciprocating manner. These stages have a two-line structure including an upper line and a lower line. Specifically, the first stage, the second stage and the third stage are disposed on the lower line, and the fourth stage is disposed on the upper line.

The lower and upper stages can freely move without interfering with each other, because they are provided at different heights. The first stage transfers a substrate between the first transferring position TP1, and the second transferring position TP2, which is a substrate receiving/delivering position. The second stage transfers a substrate between the second transferring position TP2 and the third transferring position TP3, which is a substrate receiving/delivering position. The third stage transfers a substrate between the third transferring position TP3 and the fourth transferring position TP4. The fourth stage transfers substrate between the first transferring position TP1 and the fourth transferring position TP4.

The second linear transporter 160 has substantially the same structure as the first linear transporter 150. Specifically, the fifth stage and the sixth stage are disposed on an upper line, whereas the seventh stage is disposed on a lower line. The fifth stage transfers a substrate between the fifth transferring position TP5 and the sixth transferring position TP6, which is a substrate receiving/delivering position. The sixth stage transfers a substrate between the sixth transferring position TP6 and the seventh transferring position TP7, which is a substrate receiving/delivering position. The seventh stage transfers a substrate between the fifth transferring position TP5 and the seventh transferring position TP7.

As can be understood from the fact that a slurry is used during polishing, the polishing section 130 is the dirtiest area. Therefore, in order to prevent particles from spreading out of the polishing section 130, a gas is discharged from surrounding spaces of the respective polishing tables. In addition, pressure in the interior of the polishing section 130 is set to be lower than pressures in the exterior of the apparatus, the cleaning section 140, and the loading/unloading section 102, whereby scattering of particles is prevented. Typically, discharge ducts (not shown in the drawings) are provided below the polishing tables, respectively, and filters (not shown in the drawings) are provided above the polishing tables, so that downward flows of clean air are formed from the filters to the discharge ducts.

The cleaning section 140 is an area where a polished substrate is cleaned. The cleaning section 140 includes a second transfer robot 124, a reversing machine 141 for reversing a substrate transferred from the second transfer robot 124, four cleaning units 142-145 for cleaning a polished substrate, and a transfer unit 146 for transferring a substrate between the reversing machine 141 and the cleaning units 142-145.

The second transfer robot 124, the reversing machine 141, and the cleaning units 142-145 are arranged in series along the longitudinal direction of the polishing apparatus. A filter fan unit (not shown in the drawings), having a clean air filter, is provided above the cleaning units 142-145. This filter fan unit is configured to remove particles from an air to produce a clean air, and to form downward flow of the clean air at all times. Pressure in the interior of the cleaning section 140 is kept higher than pressure in the polishing section 130, so that particles in the polishing section 130 is prevented from flowing into the cleaning section 140.

The transfer unit 46 has a plurality of arms for gripping the substrates. The substrates gripped by the arms of the transfer unit 46 are transferred between the reversing machine 141 and the cleaning units 142-145 simultaneously in a vertical direction. The cleaning unit 142 and the cleaning unit 143 may comprise, for example, a roll type cleaning unit which rotates and presses upper and lower roll-shaped sponges against front and rear surfaces of a substrate to clean the front and rear surfaces of the substrate. The cleaning unit 144 may comprise, for example, a pencil type cleaning unit which rotates and presses a hemispherical sponge against a substrate to clean the substrate. The cleaning unit 145 is the above-described substrate processing apparatus shown in FIG. 1 or 6. It is possible to additionally provide in any of the cleaning units 142-144 a megasonic-type cleaning unit, which carries out cleaning by applying ultrasonic waves to a cleaning liquid, in addition to the above-described roll-type cleaning unit or pencil-type cleaning unit.

A shutter 110 is provided between the reversing machine 151 and the first transfer robot 122. When transferring a substrate, the shutter 110 is opened, and the substrate is delivered between the first transfer robot 122 and the reversing machine 151. Shutters 111, 112, 113, and 114 are disposed between the reversing machine 141 and the second transfer robot 124, between the reversing machine 141 and the primary cleaning unit 142, between the first polishing section 130a and the second transfer robot 124, and between the second polishing section 130b and the second transfer robot 124, respectively. For transferring substrates, the shutters 111, 112, 113, and 114 are opened, and a substrate is delivered.

A polishing pad (not shown) is mounted on the polishing table 132A. The polishing table 132A is coupled to a motor (not shown) disposed below the polishing table 132A. Thus, the polishing table 132A is rotatable about its axis. As shown in FIG. 11, the top ring 133A is connected via a top ring shaft 137A to a motor and a lifting cylinder (not shown). Thus, the top ring 133A is vertically movable and rotatable about the top ring shaft 137A. The substrate is held on the lower surface of the top ring, e.g., by vacuum suction. An upper surface of the polishing pad 222 constitutes a polishing surface to polish the substrate W.

The top ring 133A, which holds the substrate W on its lower surface and rotates the substrate W, is lowered to press the substrate W against the polishing pad of the rotating polishing table 132A. At this time, a polishing liquid is supplied onto the polishing surface (upper surface) of the polishing pad by the liquid supply nozzle 134A. Thus, the substrate W is polished such a manner that the polishing liquid is present between the substrate W and the polishing pad. The polishing table 132A and the top ring 133A constitute a movement mechanism for moving the substrate W and the polishing surface relative to each other. Each of the second polishing unit 300B, the third polishing unit 300C and the fourth polishing unit 300D has the same construction as the first polishing unit 300A, therefore the description thereof is omitted.

According to the polishing apparatus having the above construction, serial processing for processing one substrate serially using four polishing units, and parallel processing for processing two substrates simultaneously can be performed.

When serial processing of a substrate is performed, the substrate is transferred on the following route: the substrate cassette of the front loading portion 120→the first transfer robot 122→the reversing machine 151→the lifter 152→the first stage of the first linear transporter 150→the pusher 153→the top ring 133A→the polishing table 132A→the pusher 153→the second stage of the first linear transporter 150→the pusher 154→the top ring 133B→the polishing table 132B the pusher 154→the third stage of the first linear transporter 150→the lifter 155→the second transfer robot 124→the lifter 166→the fifth stage of the second linear transporter 160→the pusher 167→the top ring 133C the polishing table 132C the pusher 167→the sixth stage of the second linear transporter 160→the pusher 168→the top ring 133D→the polishing table 132D→the pusher 168 the seventh stage of the second linear transporter 160 the lifter 166→the second transfer robot 124→the reversing machine 141 the transfer unit 146→the cleaning unit 142→the transfer unit 146→the cleaning unit 143 the transfer unit 146→the cleaning unit 144→→the transfer unit 146→the cleaning unit 145→the first transfer robot 122→the substrate cassette of the front loading portion 120.

When parallel processing of a substrate is performed, the substrate is transferred on the following route: the substrate cassette of the front loading portion 120→the first transfer robot 122→the reversing machine 151→the lifter 152→the first stage of the first linear transporter 150→the pusher 153→the top ring 133A→the polishing table 132A→the pusher 153→the second stage of the first linear transporter 150→the pusher 154→the top ring 133B→the polishing table 132B→the pusher 154→the third stage of the first linear transporter 150→the lifter 155→the second transfer robot 124→the reversing machine 141→the transfer unit 146→the cleaning unit 142→the transfer unit 146→the cleaning unit 143→the transfer unit 146→the cleaning unit 144→the transfer unit 146→the cleaning unit 145→the first transfer robot 122→the substrate cassette of the front loading portion 120.

Another substrate is transferred on the following route: the substrate cassette of the front loading portion 120→the first transfer robot 122→the reversing machine 151→the lifter 152→the fourth stage of the first linear transporter 150→the lifter 155→the second transfer robot 124→the lifter 166→the fifth stage of the second linear transporter 160 pusher 167→the top ring 133C→the polishing table 132C→the pusher 167→the sixth stage of the second linear transporter 160→the pusher 168→the top ring 133D→the polishing table 132D→the pusher 168→the seventh stage of the second linear transporter 160→the lifter 166→the second transfer robot 124→the reversing machine 141→the transfer unit 146→the cleaning unit 142→the transfer unit 146→the cleaning unit 143→the transfer unit 146→the cleaning unit 144→the transfer unit 146→the cleaning unit 145→the first transfer robot 122→the substrate cassette of the front loading portion 120.

While the present invention has been described with reference to the embodiments thereof, it will be understood by those skilled in the art that the present invention is not limited to the particular embodiments described above, but it is intended to cover modifications within the inventive concept.

What is claimed is:

1. A liquid scattering prevention cup, disposed such that it surrounds a periphery of a substrate held and rotated by a substrate holding mechanism, for preventing scattering of liquid droplets coming out of the rotating substrate, said liquid scattering prevention cup having
a hydrophilic coating formed on at least part of an inner peripheral surface thereof and facing the substrate held and rotated by the substrate holding mechanism,
wherein said at least part of the inner peripheral surface has been subjected to surface roughening.

2. The liquid scattering prevention cup according to claim 1, wherein the cup is made of a synthetic resin.

3. The liquid scattering prevention cup according to claim 1, wherein said at least part of the inner peripheral surface has been roughened by the surface roughening to a center line average roughness (Ra) of 0.5 to 5 μm.

4. The liquid scattering prevention cup according to claim 1, wherein the hydrophilic coating is composed of SiO₂ or a semiconductor interlevel insulator material.

5. The liquid scattering prevention cup according to claim 4, wherein the thickness of the hydrophilic coating is 0.5 to 2.0 μm.

6. The liquid scattering prevention cup according to claim 1, wherein the water contact angle of the hydrophilic coating is not more than 60 degrees.

7. The liquid scattering prevention cup according to claim 1, wherein the hydrophilic coating is formed by spray coating.

8. A substrate processing apparatus including the liquid scattering prevention cup according to claim 1.

9. A substrate polishing apparatus including the substrate processing apparatus according to claim 8.
